(19) United States
(12) Patent Application Publication
(10) Pub. No.: US 2010/0056143 A1
(43) Pub. Date: Mar. 4, 2010

(54) APPARATUS AND METHOD FOR SERVICE REGISTRATION IN A MULTI MODE PORTABLE TERMINAL

(75) Inventors: Su-Yong Yang, Gunpo-si (KR); Noh-Sun Kim, Seoul (KR); Chang-Ho Sohn, Seongnam-si (KR); Jung-Min Oh, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/506,125

(22) Filed: Jul. 20, 2009

(30) Foreign Application Priority Data
Aug. 26, 2008 (KR) 10-2008-0083291

(51) Int. Cl. H04W 60/00; H04M 1/00

(52) U.S. Cl. 455/435.1; 455/552.1

(57) ABSTRACT

An apparatus and method for service registration in a multi mode portable terminal are provided. The apparatus includes a system registration manager for, if a rejection corresponding to service disability is generated during a registration process with a first network, processing to reboot the multi mode portable terminal.

### PRIORITY

This application claims the benefit under 35 U.S.C. §119(a) of a Korean Patent application filed in the Korean Intellectual Property Office on Aug. 26, 2008 and assigned Serial No. 10-2008-0083291, the entire disclosure of which is hereby incorporated by reference.

### BACKGROUND OF THE INVENTION

1. Field of the Invention

The present invention relates to an apparatus and method for network registration of a multi mode portable terminal. More particularly, the present invention relates to an apparatus and method for releasing a service disability state in a multi mode portable terminal resulting from a registration rejection generated while attempting to register with a network and attempting registration to a different network.

2. Description of the Related Art

A Universal Mobile Telecommunication System (UMTS) in which a portable terminal or computer can transmit digitized voice or video and multimedia data at a high speed of 2 Mbps or more has recently been developed under the 3^{rd} Generation Partnership Project (3GPP).

Commercial implementation of the UMTS has now begun in many countries and it is expected that the UMTS will become the leading 3GPP technology implemented. Compared to legacy 2^{nd} Generation (2G) communication systems, the UMTS can more efficiently provide a high speed data/multimedia service and, since worldwide use is expected, can provide a global roaming function.

A portable terminal (also referred to herein as a Mobile Station (MS) or Mobile Equipment (ME)) supporting UMTS may be a multi mode portable terminal that is capable of supporting a 2G communication system (i.e., a Global System for Mobile (GSM) communications system) and a 3^{rd} Generation (3G) communication system (i.e., a UMTS communications system). The portable terminal can change a communication mode according to a signal received from each system in order to maintain continuous communication capabilities.

The communication mode indicates a network environment for which a portable terminal is set. For example, the communication mode indicates an environment for, upon call connection, setting up the use of both a 3G communication mode and a 2G communication mode or the use of only one communication mode among the 2G communication mode and the 3G communication mode.

The above multi mode portable terminal searches for signals for communication modes supported by the portable terminal, selects the most suitable communication mode among these, and attempts registration.

If a registration rejection is received in a corresponding communication mode, i.e., a corresponding network during the above registration process of the multi mode portable terminal, a service disability state is maintained until the multi mode portable terminal powers off or a Universal Subscriber Identity Module/Subscriber Identity Module (USIM/SIM) is uninstalled.

Rejections of a network kept in a service disability state as described above may correspond to one of #2 (International Mobile Subscriber Identity (IMSI) unknown in Home Location Register (HLR)), #3 (Illegal MS), and #6 (Illegal ME) among rejection causes referred to in a 3GPP specification, and are defined as follows.

#2; IMSI unknown in HLR

This cause is sent to the MS if the MS is not known (registered) in the HLR.

#3; Illegal MS

This cause is sent to the MS when the network refuses service to the MS either because an identity of the MS is not acceptable to the network or because the MS does not pass an authentication check, i.e. a Signed RESult (SRES) received from the MS is different from that generated by the network.

#6; Illegal ME

This cause is sent to the MS if the ME used is not acceptable to the network, e.g. blacklisted.

For example, in a location registration process of a multi mode portable terminal in a mobile communication system in which Wideband Code Division Multiple Access (WCDMA) and GSM signals are mixed, if a registration rejection (i.e., a registration rejection corresponding to the service disability described above: Rejection causes #2, #3, or #6) is generated only in the WCDMA network and a normal service is possible in the GSM network, the multi mode portable terminal should power off or uninstall a USIM/SIM to attempt registration after searching for a WCDMA signal. That is, since the multi mode portable terminal is in a service disability state until powering off or uninstalling the USIM/SIM as above, it cannot use the service.

In contrast, a portable terminal that only supports a GSM mode performs location registration with a GSM network and thus service acquisition and normal service is possible. Nevertheless, there is a problem in that a multi mode portable terminal is in a service disability state and thus, using a service is impossible (i.e., all normal services except for an emergency call are prohibited).

### SUMMARY OF THE INVENTION

An aspect of the present invention is to address at least the above-mentioned problems and/or disadvantages and to provide at least the advantages described below. Accordingly, an aspect of the present invention is to provide an apparatus and method for releasing a service disability state in a multi mode portable terminal resulting from a registration rejection generated while attempting to register with a network and attempting registration to a different network.

Another aspect of the present invention is to provide an apparatus and method for, if a service disability state is generated in a multi mode portable terminal, automatically releasing the service disability state.

Still another aspect of the present invention is to provide an apparatus and method for, if a service disability state is generated in a multi mode portable terminal, automatically rebooting to address a service disability state.

The above aspects are addressed by providing an apparatus and method for service registration in a multi mode portable terminal.

In accordance with an aspect of the present invention, an apparatus for performing network registration in a multi mode portable terminal is provided. The apparatus includes a system registration manager for, if a rejection corresponding to service disability is generated during a registration process with a first network, processing to reboot the multi mode portable terminal.

In accordance with another aspect of the present invention, a method for performing network registration in a multi mode portable terminal is provided. The method includes, if a rejection corresponding to service disability is generated during a registration process with a first network, rebooting the multi mode portable terminal.

In accordance with yet another aspect of the present invention, a method for performing network registration in a multi mode portable terminal is provided. The method includes searching for a first network for service registration according to a priority order of networks for service registration, the first network having a highest priority in the priority order of networks for service registration, if the first network is found, registering with the first network, if a rejection corresponding to a service disability is generated during the registering with the first network, rebooting the multi mode portable terminal, if the multi mode portable terminal is rebooted, searching for a second network for service registration according to the priority order of networks for service registration, the second network having the next highest priority in the priority order of networks for service registration, and if the second network is found, registering with the second network.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a construction of a multi mode portable terminal according to an exemplary embodiment of the present invention; and

FIG. 2 is a flow diagram illustrating a process for performing network registration in a multi mode portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The following description relates to an apparatus and method for releasing a service disability state in a multi mode portable terminal resulting from a registration rejection generated while attempting to register with a network and attempting registration to a different network. A portable terminal may also be referred to herein as a Mobile Station (MS) or Mobile Equipment (ME).

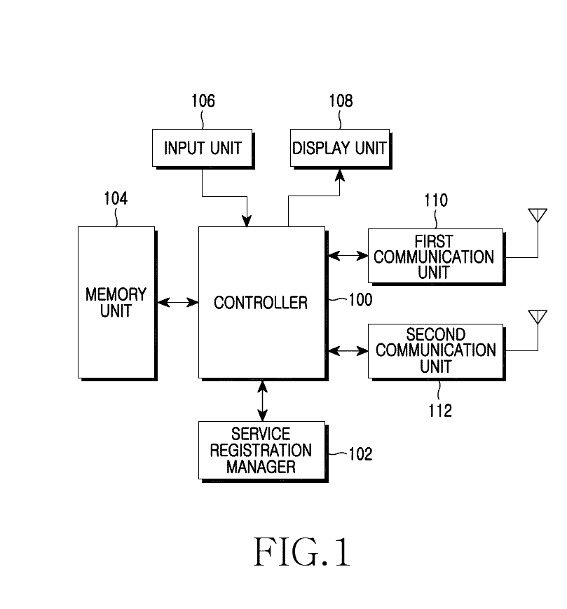

FIG. 1 is a block diagram illustrating a construction of a multi mode portable terminal according to an exemplary embodiment of the present invention.

Referring to FIG. 1, the multi mode portable terminal can include a controller 100, a service registration manager 102, a memory unit 104, an input unit 106, a display unit 108, a first communication unit 110, and a second communication unit 112.

The controller 100 of the multi mode portable terminal controls overall operations of the multi mode portable terminal. For example, the controller 100 processes and controls voice and data communications, and controls registration to a corresponding network according to a preset service priority order. In addition to a general function, when registering to a corresponding network based on the priority order, according to an exemplary embodiment of the present invention, if a rejection is received from the corresponding network that informs of a disallowance of service registration, that is, if not successfully performing a location registration process with the corresponding network because of a rejection corresponding to service disability, the controller 100 processes to perform a rebooting process of the multi mode portable terminal. When performing the rebooting process, after displaying a message informing of the service disability on the display unit 108, the controller 100 may process to reboot according to user's selection or may automatically reboot upon service disability. Here, the rejection corresponding to the service disability, which is a rejection regarded as a continuous registration failure until a SIM or a USIM is uninstalled, corresponds to one of #2 (International Mobile Subscriber Identity (IMSI) unknown in Home Location Register (HLR)), #3 (Illegal MS), and #6 (Illegal ME) among rejection causes referred in a 3^{rd} Generation Partnership Project (3GPP) specification, and is defined as follows.

#2; IMSI unknown in HLR

This cause is sent to the MS if the MS is not known (registered) in the HLR.

#3; Illegal MS

This cause is sent to the MS when the network refuses service to the MS either because an identity of the MS is not acceptable to the network or because the MS does not pass an authentication check, i.e. a Signed RESult (SRES) received from the MS is different from that generated by the network.

#6; Illegal ME

This cause is sent to the MS if the ME used is not acceptable to the network, e.g. blacklisted.

The rejection corresponding to the service disability can be a rejection corresponding to a case (#2) where a portable terminal cannot register to an HLR, a case (#3) where, because information of a portable terminal is not permitted for network access or an authentication for network access fails, a service rejection occurs, or a case (#6) where a portable terminal cannot access a network.

The service registration manager 102 determines if there is a rejection corresponding to a service disability under control of the controller 100. If it is determined that there is a rejection corresponding to the service disability, the service registration manager 102 processes to reboot the multi mode portable terminal.

The memory unit 104 may include a Read Only Memory (ROM) and a Random Access Memory (RAM). The ROM may store a microcode of a program for processing and controlling the controller 100 and the service registration manager 102, and various reference data and, according to an exemplary embodiment of the present invention, stores a preset service priority order of the multi mode portable terminal under control of the controller 100.

The RAM may be a working memory of the controller 100 and may temporarily store data generated during the execution of various programs.

Here, the memory unit 104 may be mountable and dismountable in the multi mode portable terminal, may have its own micro processor and memory chip, and may include a SIM card for storing various user's information.

The input unit 106 may include one or more of numeral key buttons ‘0’ to ‘9’, a menu button, a cancel button (delete), an OK button, a talk button, an end button, an Internet button, a plurality of function keys such as a navigation key, a character input key and the like. The input unit 106 provides key input data to the controller 100 corresponding to a key actuated by a user.

The display unit 108 displays information generated during operation of the multi mode portable terminal, a limited number of characters, a large amount of moving pictures and still pictures and the like. The display unit 108 can be implemented using a color or monochrome Liquid Crystal Display (LCD). If the LCD is provided as a touch screen, the display unit 108 may perform a part or all of the functions of the input unit 106.

The first communication unit 110 is a communication unit for, upon reception, performing a function of down-converting a wireless frequency signal received through an antenna and channel-decoding the receive signal and, upon transmission, channel-decoding, up-converting, and transmitting data through the antenna, and operates if a first communication mode is selected by the controller 100.

Like the first communication unit 110, the second communication unit 112 is a communication unit for, upon reception, performing a function of down-converting a wireless frequency signal received through an antenna and channel-decoding the receive signal and, upon transmission, channel-decoding, up-converting, and transmitting data through the antenna, and operates if a second communication mode is selected by the controller 100.

If the first communication unit 110 of the multi mode portable terminal is a communication unit supporting a 2^{nd} Generation (2G) communication mode, the second communication unit 112 will be a communication unit supporting a 3^{rd} Generation (3G) communication mode.

While the service registration manager 102 is illustrated in FIG. 1 and described herein as being separate from the controller 100, the service registration manager 102 may be implemented by the controller 100. Further, it will be understood by those skilled in the art that various modified constructions of the portable terminal are possible within the scope of the present invention. For example, any number of the components of the portable terminal described herein may be combined into a single component. Further, any function of any component of the portable terminal described herein may be separately formed constructed

The above description is for an apparatus for releasing a service disability state in a multi mode portable terminal resulting from a registration rejection generated while attempting to register with a network and attempting registration to a different network. The following description is for a method for releasing a service disability state in a multi mode portable terminal resulting from a registration rejection generated while attempting to register with a network and attempting registration to a different network using the apparatus according to an exemplary embodiment of the present invention.

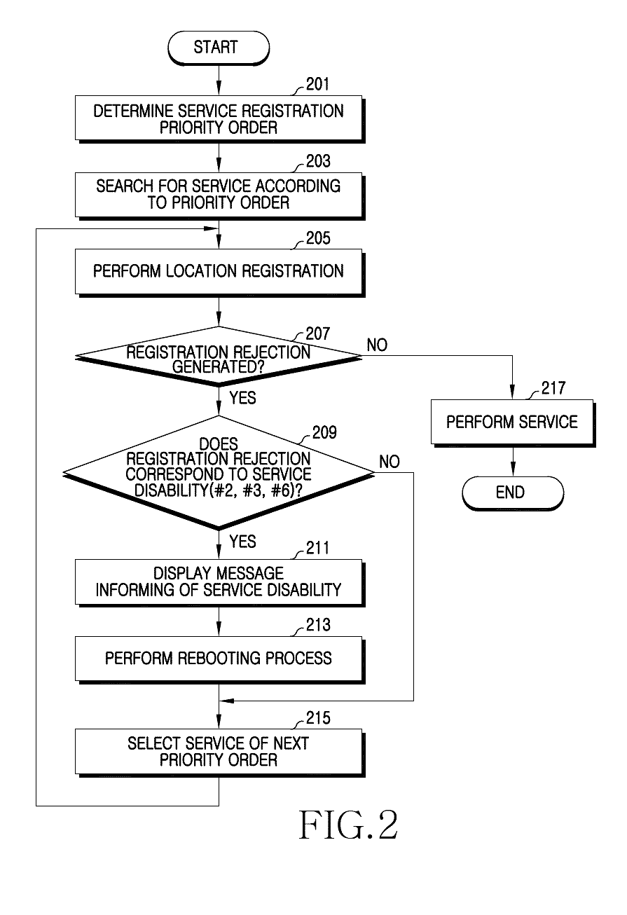

FIG. 2 is a flow diagram illustrating a process for performing network registration in a multi mode portable terminal according to an exemplary embodiment of the present invention.

Referring to FIG. 2, in step 201, the multi mode portable terminal determines a preset service registration priority order. The service registration priority order may be a sequence for service registration of the multi mode portable terminal. For example, if the multi mode portable terminal supports a GSM service and a WCDMA service, the service registration priority order represents a service registration sequence (e.g., an access sequence: (1) WCDMA, (2) GSM) that is set by a user or as a default.

In step 203, the multi mode portable terminal performs a service search process according to a priority order, that is, a process of searching for a receive signal of a network according to the determined priority order. Proceeding to step 205, the multi mode portable terminal performs location registration to the found service.

For example, if the multi mode portable terminal is set to use a WCDMA service based on a priority order, the multi mode portable terminal searches for a receive signal of the WCDMA service and then, attempts location registration.

In step 207, the multi mode portable terminal determines if it receives a rejection that informs of a service registration disallowance from a corresponding network of a service while attempting to perform location registration in step 205.

If the location registration process is successfully performed and a registration rejection is not received, the multi mode portable terminal proceeds to step 217 to access a corresponding network and perform a corresponding service. The multi mode portable terminal then terminates the process according to an exemplary embodiment of the present invention.

If the location registration process is not successfully performed and a registration rejection is received, the multi mode portable terminal proceeds to step 209 to determine if the rejection received in step 207 is a rejection corresponding to a service disability. The rejection corresponding to the service disability, which is a rejection continuously regarded as a registration failure until a SIM or a USIM is uninstalled, represents a location registration failure defined in a 3GPP specification, i.e., represents a case (#2) where a portable terminal cannot register to an HLR, a case (#3) where, because information of a portable terminal is not permitted for network access or an authentication for network access fails, a service rejection occurs, or a case (#6) where a portable terminal cannot access a network.

If it is determined that the rejection is not the rejection corresponding to the service disability, the multi mode portable terminal proceeds to step 215 to select a service of a next priority order and then again performs the process of step 205.

If it is determined that the rejection corresponds to the service disability, the multi mode portable terminal proceeds to step 211 and displays a message informing of service disability on a display unit and then, proceeds to step 213 to perform a rebooting process of the multi mode portable terminal.

Here, after displaying the message informing of the service disability, the multi mode portable terminal can perform a rebooting process of the multi mode portable terminal according to a selection of a user of the multi mode portable terminal or, if determining that the rejection corresponds to the service disability, automatically perform a rebooting process of the multi mode portable terminal.

In step 215, the multi mode portable terminal checks the service registration priority order and selects a service of a next priority order according to the location registration process failure.

Thereafter, the multi mode portable terminal performs the process of step 205.

That is, if is determined that a registration rejection corresponding to a service disability is generated, the multi mode portable terminal reboots and registers to a different network system.

At this time, if receiving a registration rejection corresponding to a service disability (e.g., a 3GPP specification location registration failure, i.e., causes (#2, #3, and #6)) from a corresponding network system, the multi mode portable terminal determines if a next priority order system exists, selects a service mode as a corresponding mode, and attempts to reboot automatically or according to a user's selection. Before rebooting, the multi mode portable terminal can attempt location registration including a signal search for service acquisition to a new network system using a mode set value of the multi mode portable terminal. The multi mode portable terminal repeats the above described operation until normal service acquisition is possible and, if service disability is generated for all service modes supportable, the multi mode portable terminal will then remain in the service disability state.

As described above, if a service disability state is generated at the time of service registration in a multi mode portable terminal, the present invention reboots the portable terminal according to user's selection or automatically and processes to attempt registration to a different network. Thereby, the multi mode portable terminal is capable of performing registration to a different network without a power off process or a SIM card uninstall process that is implemented to release service disability in a conventional multi mode portable terminal, which reduces a load of a network system and improves a chance of a service use.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for performing network registration in a multi mode portable terminal, the apparatus comprising:
a system registration manager for, if a rejection corresponding to service disability is generated during a registration process with a first network, processing to reboot the multi mode portable terminal.

2. The apparatus of claim 1, wherein, after processing to reboot the multi mode portable terminal, the system registration manager processes to register the multi mode portable terminal with a second network.

3. The apparatus of claim 2, wherein the second network is next in a priority order among a preset priority order of networks for service registration.

4. The apparatus of claim 1, wherein, after displaying a message informing a user of the service disability, the system registration manager processes to perform the rebooting according to a user's selection.

5. The apparatus of claim 1, wherein the processing to reboot the multi mode portable terminal is performed automatically.

6. The apparatus of claim 1, wherein the rejection corresponding to the service disability comprises a rejection that is continuously regarded as a registration failure until one of a Subscriber Identity Module (SIM) and a Universal Subscriber Identity Module (USIM) is uninstalled.

7. The apparatus of claim 6, wherein the rejection corresponding to the service disability is caused by at least one of #2 (International Mobile Subscriber Identity (IMSI) unknown in Home Location Register (HLR)), #3 (Illegal Mobile Station (MS)), and #6 (Illegal Mobile Equipment (ME)) among rejection causes specified in a 3 Generation Partnership Project (3GPP) specification.

8. A method for performing network registration in a multi mode portable terminal, the method comprising:
if a rejection corresponding to service disability is generated during a registration process with a first network, rebooting the multi mode portable terminal.

9. The method of claim 8, further comprising, after rebooting the multi mode portable terminal, registering with a second network.

10. The method of claim 9, wherein the second network is next in a priority order among a preset priority order of networks for service registration.

11. The method of claim 8, wherein the rebooting of the multi mode portable terminal comprises, after displaying a message informing a user of the service disability, performing the rebooting according to a user's selection.

12. The method of claim 8, wherein the rebooting of the multi mode portable terminal comprises automatically performing the rebooting.

13. The method of claim 8, wherein the rejection corresponding to the service disability comprises a rejection that is continuously regarded as a registration failure until one of a Subscriber Identity Module (SIM) and a Universal Subscriber Identity Module (USIM) is uninstalled.

14. The method of claim 13, wherein the rejection corresponding to the service disability is caused by at least one of #2 (International Mobile Subscriber Identity (IMSI) unknown in Home Location Register (HLR)), #3 (Illegal Mobile Station (MS)), and #6 (Illegal Mobile Equipment (ME)) among rejection causes specified in a 3 Generation Partnership Project (3GPP) specification.

15. A method for performing network registration in a multi mode portable terminal, the method comprising:
searching for a first network for service registration according to a priority order of networks for service registration, the first network having a highest priority in the priority order of networks for service registration;
if the first network is found, registering with the first network;
if a rejection corresponding to a service disability is generated during the registering with the first network, rebooting the multi mode portable terminal;
if the multi mode portable terminal is rebooted, searching for a second network for service registration according to the priority order of networks for service registration, the second network having the next highest priority in the priority order of networks for service registration; and
if the second network is found, registering with the second network.

16. The method of claim 15, wherein if the rejection corresponds to a service disability generated during the registering with the first network, determining if the rejection is caused by at least one of #2 (International Mobile Subscriber Identity (IMSI) unknown in Home Location Register (HLR)), #3 (Illegal Mobile Station (MS)), and #6 (Illegal Mobile Equipment (ME)) among rejection causes specified in a 3 Generation Partnership Project (3GPP) specification.

17. The method of claim 16, wherein, if it is determined that the rejection is caused by at least one of #2 (International Mobile Subscriber Identity (IMSI) unknown in Home Location Register (HLR)), #3 (Illegal Mobile Station (MS)), and #6 (Illegal Mobile Equipment (ME)) among rejection causes specified in a 3 Generation Partnership Project (3GPP) specification, displaying a message informing a user of the service disability, and performing the rebooting according to a user's selection.

18. The method of claim 16, wherein, if it is determined that the rejection is caused by at least one of #2 (International Mobile Subscriber Identity (IMSI) unknown in Home Location Register (HLR)), #3 (Illegal Mobile Station (MS)), and #6 (Illegal Mobile Equipment (ME)) among rejection causes specified in a 3 Generation Partnership Project (3GPP) specification, automatically performing the rebooting.

19. The method of claim 15, wherein the rejection corresponding to the service disability comprises a rejection that is continuously regarded as a registration failure until one of a Subscriber Identity Module (SIM) and a Universal Subscriber Identity Module (USIM) is uninstalled.

20. An apparatus for performing network registration in a multi mode portable terminal, the apparatus comprising:
means for searching for a first network for service registration according to a priority order of networks for service registration, the first network having a highest priority in the priority order of networks for service registration;
means for registering with the first network if the first network is found;
means for rebooting the multi mode portable terminal if a rejection corresponding to a service disability is generated during the registering with the first network;
means for searching for a second network for service registration according to the priority order of networks for service registration, the second network having the next highest priority in the priority order of networks for service registration if the multi mode portable terminal is rebooted; and
means for registering with the second network if the second network is found.
